(19) United States
(12) Patent Application Publication
(10) Pub. No.: US 2013/0280594 A1
(43) Pub. Date: Oct. 24, 2013

(54) NONAQUEOUS ELECTROLYTE SECONDARY BATTERY

(71) Applicants: Tetsuya Kajita, Kanagawa (JP); Ryuichi Kasahara, Kanagawa (JP); Jiro Iriyama, Kanagawa (JP); Tatsuji Numata, Kanagawa (JP)

(72) Inventors: Tetsuya Kajita, Kanagawa (JP); Ryuichi Kasahara, Kanagawa (JP); Jiro Iriyama, Kanagawa (JP); Tatsuji Numata, Kanagawa (JP)

(73) Assignee: NEC ENERGY DEVICES, LTD., Kanagawa (JP)

(21) Appl. No.: 13/977,895

(22) PCT Filed: Jan. 18, 2011
(86) PCT No.: PCT/JP2011/050709

§ 371 Date: Jul. 1, 2013

(51) Int. Cl. H01M 4/134

(52) U.S. Cl. CPC H01M 4/134
USPC 429/163; 429/211

(57) ABSTRACT

In a nonaqueous electrolyte secondary battery using silicon and silicon oxide as a negative electrode active material, the charge and discharge cycle characteristics are improved. A nonaqueous electrolyte secondary battery in the exemplary embodiment comprises a sheet-shaped negative electrode comprising a negative electrode active material layer comprising a composite of silicon and silicon oxide formed on a negative electrode current collector, and a sheet-shaped positive electrode comprising a positive electrode active material layer formed on a positive electrode current collector, wherein the negative electrode is disposed opposed to the positive electrode via a separator, a peripheral edge portion of the negative electrode active material layer is disposed within a peripheral edge portion of the positive electrode active material layer, and a relationship of 1.00<c is satisfied when a charge capacity of the positive electrode is a, a charge capacity of the negative electrode is b, and b/a=c is set.

### TECHNICAL FIELD

The present invention relates to a nonaqueous electrolyte secondary battery, such as a lithium secondary battery.

### BACKGROUND ART

Currently, with the spread of mobile equipment, such as cellular phones and notebook computers, the role of secondary batteries, which are the power sources of the mobile equipment, is regarded as important. Performance required of secondary batteries include small size, light weight, and high capacity and not being easily degraded even by the repetition of charge and discharge, and currently, lithium ion secondary batteries are most commonly used.

Carbon, such as graphite and hard carbon, is mainly used for the negative electrodes of lithium ion secondary batteries. With carbon, a charge and discharge cycle can be repeated well, but actual capacity is close to the theoretical capacity limits and thus significant capacity improvement cannot be expected in the future. On the other hand, the demand for an improvement in the capacity of lithium ion secondary batteries is strong, and studies of negative electrode materials having higher capacity, that is, higher energy density, than carbon have been undertaken.

Examples of negative electrode materials capable of achieving high energy density include silicon. In fact, Non Patent Literature 1 describes the use of silicon as a negative electrode active material.

A negative electrode using silicon has a large amount of absorbed and desorbed lithium ions per unit volume and high capacity. However, pulverization proceeds because the expansion and shrinkage of the electrode active material itself are large when lithium ions are absorbed and desorbed. The irreversible capacity in initial charge and discharge is large, and a portion not used for charge and discharge is formed on the positive electrode side. In addition, a problem is that the charge and discharge cycle life is short.

On the other hand, Patent Literature 1 proposes a nonaqueous electrolyte secondary battery using silicon oxide as a negative electrode active material, and a method for manufacturing the same. Patent Literature 1 describes a nonaqueous electrolyte secondary battery that has high energy density and excellent cycle life by using silicon oxide as the active material.

In a lithium ion secondary battery in the current state, in the positive electrode and negative electrode that face, the electrode area on the negative electrode side is larger than the electrode area on the positive electrode side, a portion that does not face the positive electrode is present in the negative electrode, and the negative electrode portion that does not face the positive electrode does not contribute to charge and discharge reactions.

In the case of a negative electrode using silicon in which the volume change due to charge and discharge is large, a difference occurs in the elongation of the electrode between the portion that does not face the positive electrode, as described above, and the portion facing the positive electrode, and a cut in the electrode occurs in the portion not facing the positive electrode.

In a battery that uses, as the negative electrode active material, silicon in which the volume change due to charge and discharge is large, the occurrence of the above mentioned cut causes the electrode to easily peel off, and thus the charge and discharge cycle life is adversely affected.

As a method for suppressing this cut in the electrode, a method in which the electrode area of the negative electrode is made smaller than the electrode area of the positive electrode is considered.

In Patent Literature 2, the charge and discharge cycle life characteristics are successfully improved by making the electrode area of a negative electrode using lithium titanate equal to the electrode area of a positive electrode, and making the capacity of the negative electrode equal to the capacity of the positive electrode. However, in a battery using silicon for a negative electrode active material, when the capacity of the negative electrode is made equal to or smaller than the capacity of the positive electrode, the charge and discharge cycle life is adversely affected, and a sufficient effect is not obtained.

### CITATION LIST

### Patent Literature

Patent Literature 1: JP2997741B
Patent Literature 2: JP2008-517419A

### Non Patent Literature

Non Patent Literature 1: Li and four others, A High Capacity Nano-Si Composite Anode Material for Lithium Rechargeable Batteries, Electrochemical and Solid-State Letters, Vol. 2, No. 11, p. 547-549 (1999)

### SUMMARY OF INVENTION

### Technical Problem

A problem of the exemplary embodiment is to improve charge and discharge cycle characteristics in a nonaqueous electrolyte secondary battery using silicon and silicon oxide for a negative electrode as a negative electrode active material.

### Solution to Problem

In order to solve the above problem, an exemplary embodiment of the present invention relates to a nonaqueous electrolyte secondary battery, wherein a sheet-shaped negative electrode comprising a negative electrode active material layer comprising a composite of silicon and silicon oxide formed on a negative electrode current collector is disposed opposite a sheet-shaped positive electrode comprising a positive electrode active material layer formed on a positive electrode current collector via a separator, a peripheral edge portion of the negative electrode active material layer is disposed within a peripheral edge portion of the positive electrode active material layer, and a relationship of 1.00<c is satisfied when a charge capacity of the positive electrode is a, a charge capacity of the negative electrode is b, and b/a=c is set.

In addition, the nonaqueous electrolyte secondary battery in the exemplary embodiment is a film-packaged, electrode-laminated type.

### Advantageous Effect of Invention

According to the exemplary embodiment, a nonaqueous electrolyte secondary battery that suppresses occurrence of a cut in the negative electrode and has high capacity and excellent charge and discharge cycle characteristics can be obtained.

### BRIEF DESCRIPTION OF DRAWINGS

FIG. 1 is a cross-sectional view of a nonaqueous electrolyte secondary battery in the exemplary embodiment.

FIG. 2 is a graph showing a capacity retention rate depending on charge and discharge cycles in Example 2 and Example 8.

### DESCRIPTION OF EMBODIMENTS

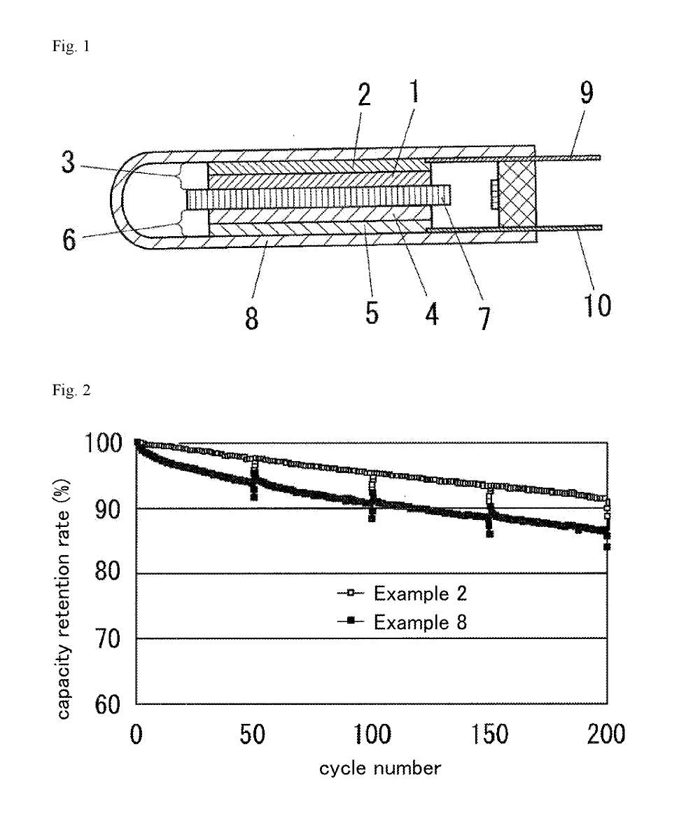

A nonaqueous electrolyte secondary battery in the exemplary embodiment will be described with reference to the drawings. As shown in FIG. 1, the nonaqueous electrolyte secondary battery in the exemplary embodiment has a structure in which negative electrode 3 comprising negative electrode active material layer 1 formed on negative electrode current collector 2, such as copper foil, and a positive electrode 6 comprising positive electrode active material layer 4 formed on positive electrode current collector 5, such as aluminum foil, are disposed opposite each other via separator 7. As separator 7, porous films of polyolefins, such as polypropylene and polyethylene, fluororesins, and the like can be used. Negative electrode lead tab 9 and positive electrode lead tab 10 for taking electrode terminals out are pulled out of negative electrode 3 and positive electrode 6, respectively, and the nonaqueous electrolyte secondary battery is packaged except for the respective tips of negative electrode lead tab 9 and positive electrode lead tab 10 using packaging film 8, such as a laminate film.

The negative electrode is obtained by forming the negative electrode active material layer on the negative electrode current collector. The negative electrode active material layer comprises a negative electrode active material and a binder resin. The negative electrode active material comprises at least a composite of silicon (Si) and silicon oxide (SiO₂) capable of absorbing and desorbing lithium. In addition, the negative electrode active material preferably comprises a conductive agent, such as a carbon material.

The negative electrode active material layer 1 can be formed using, for example, a mixture obtained by mixing a negative electrode active material, a carbon material, and a binder resin. The negative electrode can be processed into a well-known form. For example, the negative electrode can be obtained as an application type electrode plate by applying a paste prepared by kneading the mixture with a solvent, on metal foil, such as copper foil, and rolling the metal foil with the paste. In addition, the negative electrode can be obtained as a pressed electrode plate by pressing a paste prepared by kneading the mixture with a solvent, directly on metal foil, such as copper foil. Specifically, for example, the negative electrode can be obtained by dispersing a composite powder comprising Si and SiO₂, a carbon powder, and a binder resin in a solvent, such as N-methyl-2-pyrrolidone (NMP), and kneading them; applying the obtained paste on negative electrode current collector 2 comprising metal foil; and drying the paste on negative electrode current collector 2 in a high temperature atmosphere.

Examples of the binder resin can include thermosetting binding agents typified by polyimides, polyamides, polyamideimides, polyacrylic resins, and polymethacrylic resins.

As the conductive agent, for example, carbon materials can be used as described above. As the carbon materials, for example, graphite, amorphous carbon, diamond-like carbon, carbon nanotubes, or composites thereof can be used. In addition, as the carbon materials, specifically, carbon black, acetylene black, and the like may be mixed.

The electrode density of produced negative electrode active material layer 1 is preferably 0.5 g/cm³ or more and 2.0 g/cm³ or less. When the electrode density is 0.5 g/cm³ or more, the absolute value of the discharge capacity is large, and advantages over conventional carbon materials are easily obtained. In addition, when the electrode density is 2.0 g/cm³ or less, the electrode is easily impregnated with the electrolytic solution, and the discharge capacity is improved.

The thickness of negative electrode current collector 2 is preferably 4 to 100 μm because it is preferable to provide such a thickness that can maintain strength. The thickness of negative electrode current collector 2 is further preferably 5 to 30 μm in order to increase energy density.

The positive electrode is obtained by forming the positive electrode active material layer on the positive electrode current collector. The positive electrode active material layer comprises a positive electrode active material and a binder resin. The positive electrode active material is not particularly limited, and comprises, for example, an oxide capable of absorbing and desorbing lithium. In addition, the positive electrode can comprise a conductive agent, such as carbon black or acetylene black, for providing conductivity.

Positive electrode active material layer 4 can be formed using a mixture obtained by mixing a positive electrode active material, a conductive agent, and a binder resin. Specifically, positive electrode active material layer 4 is formed by dispersing an oxide capable of absorbing and desorbing lithium, a conductive agent, and a binder resin in a solvent, such as N-methyl-2-pyrrolidone (NMP) or dehydrated toluene, and kneading them; applying the kneaded material on positive electrode current collector 5 comprising metal foil; and drying the material on positive electrode current collector 5 in a high temperature atmosphere.

Examples of the binder resin can include polyvinylidene fluoride, a vinylidene fluoride-hexafluoropropylene copolymer, vinylidene fluoride-tetrafluoroethylene copolymer, and polytetrafluoroethylene.

The electrode density of positive electrode active material layer 4 can be 2.0 g/cm³ or more and 3.0 g/cm³ or less. When the electrode density is 2.0 g/cm³ or more, the absolute value of the discharge capacity is large. In addition, when the electrode density is 3.0 g/cm³ or less, the electrode is easily impregnated with the electrolytic solution, and the discharge capacity is improved.

The thickness of positive electrode current collector 5 is preferably 4 to 100 μm because it is preferable to provide such a thickness that can maintain strength. The thickness of the positive electrode current collector 5 is further preferably 5 to 30 μm in order to increase energy density.

In addition, the electrolytic solution used in the nonaqueous electrolyte secondary battery comprises a nonaqueous electrolytic solution and a lithium salt. Examples of the nonaqueous electrolytic solution can include aprotic organic solvents, such as cyclic-type carbonates, such as propylene carbonate (PC), ethylene carbonate (EC), butylene carbonate (BC), and vinylene carbonate (VC), linear-type carbonates, such as dimethyl carbonate (DMC), diethyl carbonate (DEC), ethyl methyl carbonate (EMC), and dipropyl carbonate (DPC), aliphatic carboxylates, such as methyl formate, methyl acetate, and ethyl propionate, γ-lactones, such as γ-butyrolactone, linear-type ethers, such as 1,2-ethoxyethane (DEE) and ethoxymethoxyethane (EME), cyclic-type ethers, such as tetrahydrofuran and 2-methyltetrahydrofuran, dimethyl sulfoxide, 1,3-dioxolane, formamide, acetamide, dimethylformamide, dioxolane, acetonitrile, propylnitrile, nitromethane, ethyl monoglyme, phosphate triester, trimethoxymethane, dioxolane derivatives, sulfolane, methylsulfolane, 1,3-dimethyl-2-imidazolidinone, 3-methyl-2-oxazolidinone, propylene carbonate derivatives, tetrahydrofuran derivatives, ethyl ether, 1,3-propanesultone, anisole, and N-methylpyrrolidone. For the nonaqueous electrolytic solution, one or two or more materials can be mixed and used.

Examples of the lithium salt include LiPF₆, LiAsF₆, LiAlCl₄, LiClO₄, LiBF₄, LiSbF₆, LiCF₃SO₃, LiCF₃CO₂, Li(CF₃SO₂)₂, LiN(CF₃SO₂)₂, LiB₁₀Cl₁₀, lower aliphatic lithium carboxylates, chloroborane lithium, lithium tetraphenylborate, LiBr, LiI, LiSCN, LiCl, and imides.

In addition, in the nonaqueous electrolyte secondary battery in the exemplary embodiment, a polymer electrolyte, a solid electrolyte, or an ionic liquid can be used instead of the above electrolytic solution.

In addition, the discharge termination voltage value of the nonaqueous electrolyte secondary battery manufactured as described above is desirably 1.5 V or more and 2.7 V or less. When the discharge termination voltage value is 1.5 V or more, there is a tendency that degradation of discharge capacity due to repeated charging and discharging is reduced, and the circuit design becomes to be easy. In addition, when the discharge termination voltage value is 2.7 V or less, the absolute value of the discharge capacity is large, and advantages over conventional carbon materials are easily obtained.

In the nonaqueous electrolyte secondary battery in the exemplary embodiment, silicon and silicon oxide are used for the negative electrode as the negative electrode active material, the positive electrode and the negative electrode formed in a sheet shape are disposed via the separator so that their respective active material layers are opposite each other, and the peripheral edge portion of the negative electrode active material layer is disposed so as to be within the peripheral edge portion of the positive electrode active material layer, and 1.00<c is set when the charge capacity of the positive electrode is a, the charge capacity of the negative electrode is b, and b/a=c is set. When c is larger than 1, the effect in the exemplary embodiment is obtained. In terms of increasing the energy density of the battery, c is desirably 1.45 or less. The peripheral edge portion of the negative electrode active material layer is disposed so as to be at the same position as or inside the peripheral edge portion of the positive electrode active material layer.

In the positive electrode and negative electrode that face each other, when the area of the negative electrode active material layer that faces the separator is larger than the area of the positive electrode active material layer that faces the separator, a portion that does not face the positive electrode active material layer is present in the negative electrode active material layer, and the negative electrode active material layer portion that does not face the positive electrode active material layer does not contribute to charge and discharge reactions. In the case of a negative electrode using silicon in which volume change due to charge and discharge is large, the difference in the elongation of the negative electrode active material layer during charge and discharge is large between the portion that does not face the positive electrode active material layer as described above and the portion that faces the positive electrode active material layer, and therefore, a cut in the negative electrode may occur in the portion that does not face the positive electrode. The occurrence of a cut makes the peeling of the negative electrode active material layer proceed easily, and adversely affects charge and discharge cycle life. Therefore, it is desired to make the facing area on the negative electrode side smaller than the facing area on the positive electrode side, eliminate the difference in elongation in the negative electrode active material layer during charge and discharge, and suppress a cut in the negative electrode.

### EXAMPLES

Examples in the exemplary embodiment will be described below. In the exemplary embodiment, a composite of silicon and silicon oxide is used for the negative electrode as the negative electrode active material, and a carbon material is used as the conductive agent. As a typical example thereof, the ratio of their respective molecular weights is set to 1:1:0.8.

The charge and discharge performance of the composite of silicon and silicon oxide used was previously confirmed. In other words, the capacity characteristics were confirmed at 2.0 V to 0.02 V with a model cell using metal lithium as a counter electrode. As a result, in the first charge, Li in an amount corresponding to about 2500 mAh/g per the negative electrode active material was absorbed, but in the following discharge, only about 1650 mAh/g per the negative electrode active material was discharged, and an irreversible capacity of about 850 mAh/g per the negative electrode active material was obtained.

For an oxide capable of absorbing and desorbing lithium used for the positive electrode, in these Examples, as a typical example thereof, lithium nickelate commercially available as a powder reagent was used. The capacity characteristics of the positive electrode were confirmed at 4.3 V to 3.0 V using a model cell that uses metal lithium as a counter electrode. As a result, the discharge capacity of the positive electrode that uses lithium nickelate was about 200 mAh/g, and the charge and discharge potentials were around 3.8 V.

The negative electrode was fabricated as follows. First, particles of a composite substance comprising silicon, silicon oxide, and carbon were mixed with a polyimide as a binder resin and NMP as a solvent to prepare a negative electrode material. Next, the negative electrode material was applied on 10 μm copper foil, and dried at 125° C. for 5 minutes, and then, the negative electrode material on the copper foil was subjected to compression molding by a roll press, and dried again in a N₂ atmosphere in a drying furnace at 350° C. for 30 minutes. This active material layer formed on the copper foil was punched into a predetermined size to provide a negative electrode. Then, a negative electrode lead tab for charge extraction comprising nickel was ultrasonically fused to the obtained negative electrode.

The positive electrode was fabricated as follows. First, particles of an active material comprising the above oxide capable of absorbing and desorbing lithium and the above lithium-containing transition metal oxide were mixed with polyvinylidene fluoride as a binder resin and NMP as a solvent to prepare a positive electrode material. Next, the positive electrode material was applied on 20 μm aluminum foil, and dried at 125° C. for 5 minutes. The active material layer formed on the aluminum foil was punched into 3.0×3.0 cm² to provide a positive electrode. Then, a positive electrode lead tab for charge extraction comprising aluminum was ultrasonically fused to the obtained positive electrode.

The negative electrode, a separator, and the positive electrode were laminated in this order so that the active material layers faced the separator, and then, they were sandwiched by a laminate film. An electrolytic solution was injected, and sealing was performed under vacuum to fabricate a film-packaged, electrode-laminated type nonaqueous electrolyte secondary battery using a laminate film. For the electrolytic solution, a solution obtained by dissolving 1 mol/L of LiPF₆ in a mixed solvent of EC, DEC, and EMC with a volume ratio of 3:5:2, respectively, was used.

In addition, in Example 1, as Example 1, a battery was fabricated in which γ=1.05 and c=1.21 were obtained when the area of the positive electrode active material layer opposite the separator was α, the facing area of the negative electrode active material layer was β, α/β=γ was set, the charge capacity of the positive electrode was a, the charge capacity of the negative electrode was b, and b/a=c was set.

### Example 2

A battery was fabricated as in Example 1 except that γ=1.15 and c=1.21 were obtained, and the battery was evaluated. The results are shown in Table 1.

### Example 3

A battery was fabricated as in Example 1 except that γ=1.40 and c=1.21 were obtained, and the battery was evaluated. The results are shown in Table 1.

### Example 4

A battery was fabricated as in Example 1 except that γ=1.50 and c=1.21 were obtained, and the battery was evaluated. The results are shown in Table 1.

### Example 5

A battery was fabricated as in Example 1 except that γ=1.15 and c=1.05 were obtained, and the battery was evaluated. The results are shown in Table 1.

### Example 6

A battery was fabricated as in Example 1 except that γ=1.15 and c=1.45 were obtained, and the battery was evaluated. The results are shown in Table 1.

### Example 7

In addition, in Example 7, a structure in which a three-layer structure in which a separator was sandwiched between the above positive electrode formed in a sheet shape with a size of 60×7 cm² and the above negative electrode formed in a sheet shape with a size according to an facing area ratio was concentrically wound was formed, impregnated with the above electrolytic solution, and enclosed in a metal can case to fabricate a wound type battery. In addition, in Example 7, the secondary battery was fabricated so that the conditions of γ and c were the same as Example 2.

A charge and discharge cycle test was performed for the batteries as described above. The charge and discharge test was performed at a constant current of 15 mA, a charge termination voltage of 4.2 V, a discharge termination voltage of 2.5 V, and 45° C. The discharge capacity per the weight of the negative electrode active material after 200 cycles, and the discharge capacity retention rate after 200 cycles with respect to the discharge capacity after 1 cycle (discharge capacity after 200 cycles/discharge capacity after 1 cycle) are shown in Table 1. As shown in Table 1, the discharge capacity retention rate after 200 cycles was 90% or more in the range of 1.15≦γ.

TABLE 1

| | | | Discharge capacity | |
|---|---|---|---|---|
| | | | per weight of negative | |
| | | | electrode active mate- | Discharge capacity |
| | | | rial after 200 cycles | retention rate after |
| | γ | c | (mAh/g) | 200 cycles (%) |
| Example 1 | 1.05 | 1.21 | 1105 | 88.8 |
| Example 2 | 1.15 | 1.21 | 1129 | 91.3 |
| Example 3 | 1.40 | 1.21 | 1070 | 90.8 |
| Example 4 | 1.50 | 1.21 | 1052 | 91.2 |
| Example 5 | 1.15 | 1.05 | 1398 | 90.7 |
| Example 6 | 1.15 | 1.45 | 985 | 90.5 |
| Example 7 | 1.15 | 1.21 | 980 | 90.2 |

In addition, before the charge and discharge cycle test was performed, the discharge capacity per the weight of the negative electrode when a discharge current of 75 mA was passed from the charge state at 45° C. for 1 hour was measured. The results are shown in Table 2.

There is a tendency for the discharge capacity to decrease as the value of γ increases. At γ=1.50, the value of the discharge capacity when a discharge current of 75 mA was passed was half the numerical value when a discharge current of 15 mA was passed.

TABLE 2

| | | | Discharge capacity | Discharge capacity |
|---|---|---|---|---|
| | | | per weight of negative | per weight of negative |
| | | | electrode when dis- | electrode when dis- |
| | | | charge current of | charge current of |
| | | | 15 mA was passed | 75 mA was passed |
| | γ | c | (mAh/g) | (mAh/g) |
| Example 1 | 1.05 | 1.21 | 1245 | 1150 |
| Example 2 | 1.15 | 1.21 | 1236 | 1136 |
| Example 3 | 1.40 | 1.21 | 1178 | 780 |
| Example 4 | 1.50 | 1.21 | 1153 | 558 |
| Example 5 | 1.15 | 1.05 | 1541 | 1390 |
| Example 6 | 1.15 | 1.45 | 1088 | 990 |
| Example 7 | 1.15 | 1.21 | 1086 | 967 |

### Example 8

A battery was fabricated as in Example 1 except that γ=1.00 and c=1.21 were obtained, and the battery was evaluated. The results are shown in Table 3.

### Example 9

A battery was fabricated as in Example 7 except that γ=1.00 and c=1.21 were obtained. The results are shown in Table 3.

### Comparative Example 1

A battery was fabricated as in Example 1 except that γ=1.15 and c=1.00 were obtained. The results are shown in Table 3.

### Comparative Example 2

A battery was fabricated as in Example 1 except that γ=0.85 and c=1.21 were obtained, and the battery was evaluated. The results are shown in Table 3.

In Examples 8 and 9 and Comparative Example 1, the charge and discharge test was performed at a constant current of 15 mA, a charge termination voltage of 4.2 V, a discharge termination voltage of 2.5 V, and 45° C. The discharge capacity per the weight of the negative electrode active material after 200 cycles, and the discharge capacity retention rate after 200 cycles with respect to the discharge capacity after 1 cycle are shown in Table 3. In all cases, the capacity retention rate was lower than those of the Examples.

TABLE 3

| | | | Discharge capacity | |
|---|---|---|---|---|
| | | | per weight of negative | |
| | | | electrode active mate- | Discharge capacity |
| | | | rial after 200 cycles | retention rate after |
| | γ | c | (mAh/g) | 200 cycles (%) |
| Example 8 | 1.00 | 1.21 | 1046 | 87.3 |
| Example 9 | 1.00 | 1.21 | 973 | 88.5 |
| Comparative | 1.15 | 1.00 | 780 | 63.1 |
| Example 1 | | | | |
| Comparative | 0.85 | 1.21 | 850 | 71.4 |
| Example 2 | | | | |

In addition, the results of the charge and discharge cycles in Example 2 and Example 8 are shown in FIG. 2. These two Examples are the same for all except for the area ratio of the positive electrode to the negative electrode. The one with a larger positive electrode area always showed a higher capacity retention rate at the same number of cycles. From the results of the Examples, the preferred range of γ is 1.05≦γ≦1.40, and the more preferred range is 1.15≦γ≦1.40. In addition, considering the results of the case of a discharge current of 75 mA shown in Table 2, the preferred range of γ is also 1.05≦γ≦1.15.

In this manner, it has been confirmed that in the nonaqueous electrolyte secondary battery using silicon and silicon oxide for the negative electrode as the negative electrode active material, the positive electrode and the negative electrode formed in a sheet shape are disposed via the separator so that their respective active material layers are opposite each other, and the peripheral edge portion of the negative electrode active material layer is disposed so as to be within the peripheral edge portion of the positive electrode active material layer, and 1.00<c is set when the charge capacity of the positive electrode is a, the charge capacity of the negative electrode is b, and b/a=c is set, and thus, a cut in the negative electrode is suppressed, and cycle characteristics are improved. In addition, preferably, the range of c is 1.05≦c≦1.45.

It is thought that when the capacity of the negative electrode is made smaller than the capacity of the positive electrode, Li metal is deposited on the negative electrode, and Li dendrites grow with charge and discharge cycles, leading to the deterioration of cycle characteristics and finally a short circuit between the positive electrode and the negative electrode.

In addition, it is thought that when the size ratio of the facing area of the negative electrode active material layer to the facing area of the positive electrode active material layer is increased, the resistance of the battery is high, and the rate of charge and discharge is low.

In addition, the influence of changing the facing area ratio of the positive electrode to the negative electrode on charge and discharge cycle characteristics differs depending on the shape of the battery. The effect is larger in the film-packaged, electrode-laminated type nonaqueous electrolyte secondary battery in which a large force is not applied in the direction in which the positive and negative electrodes are opposite each other than in the wound type battery in which a large force is applied in the direction in which the positive and negative electrodes are opposite each other. This is thought to be because in a case where the peeling of the electrode occurs due to a cut in the electrode, when a large force has been applied in the direction of the plane in which the positive and negative electrodes are opposite each other, the electrode material does not completely fall off the electrode due to the force even if the electrode peels, and therefore, the deactivated portion is small, and the adverse effect on charge and discharge cycle characteristics is small.

While the invention of this application has been described with reference to the exemplary embodiment and the Examples, the invention of this application is not limited to the above exemplary embodiment and Examples. In the configuration and details of the invention of this application, various changes that can be understood by those skilled in the art can be made within the scope of the invention of this application.

### REFERENCE SIGNS LIST

1 negative electrode active material layer
2 negative electrode current collector
3 negative electrode
4 positive electrode active material layer
5 positive electrode current collector
6 positive electrode
7 separator
8 packaging film
9 negative electrode lead tab
10 positive electrode lead tab

1. A nonaqueous electrolyte secondary battery, comprising a sheet-shaped negative electrode which comprises a negative electrode active material layer comprising a composite of silicon and silicon oxide formed on a negative electrode current collector, and a sheet-shaped positive electrode which comprises a positive electrode active material layer formed on a positive electrode current collector,
wherein the negative electrode is disposed opposite the positive electrode via a separator, a peripheral edge portion of the negative electrode active material layer is disposed within a peripheral edge portion of the positive electrode active material layer, and a relationship of 1.00<c is satisfied when a charge capacity of the positive electrode is a, a charge capacity of the negative electrode is b, and b/a=c is set.

2. The nonaqueous electrolyte secondary battery according to claim 1, wherein the c satisfies a relationship of 1.05≦c≦1.45.

3. The nonaqueous electrolyte secondary battery according to claim 1, wherein a relationship of 1.00≦γ is satisfied when an area of the positive electrode active material layer opposite the separator is α, an area of the negative electrode active material layer opposite the separator is β, and α/β=γ is set.

4. The nonaqueous electrolyte secondary battery according to claim 3, wherein the γ satisfies a relationship of 1.05≦γ≦1.40.

5. The nonaqueous electrolyte secondary battery according to claim 3, wherein the γ satisfies a relationship of 1.15≦γ≦1.40.

6. The nonaqueous electrolyte secondary battery according to claim 3, wherein the γ satisfies a relationship of 1.05≦γ≦1.15.

7. The nonaqueous electrolyte secondary battery according to claim 1, being a film-packaged, electrode-laminated type.

8. The nonaqueous electrolyte secondary battery according to claim 2, wherein a relationship of 1.00≦γ is satisfied when an area of the positive electrode active material layer opposite the separator is α, an area of the negative electrode active material layer opposite the separator is β, and α/β=γ is set.

9. The nonaqueous electrolyte secondary battery according to claim 8, wherein the γ satisfies a relationship of 1.05≦γ≦1.40.

10. The nonaqueous electrolyte secondary battery according to claim 8, wherein the γ satisfies a relationship of 1.15≦γ≦1.40.

11. The nonaqueous electrolyte secondary battery according to claim 8, wherein the γ satisfies a relationship of 1.05≦γ≦1.15.
